(19) United States
(12) Patent Application Publication
(10) Pub. No.: US 2004/0193496 A1
(43) Pub. Date: Sep. 30, 2004

(54) Order proposal method through computer network, order proposal program and computer-readable recording medium storing order proposal program

(75) Inventor: Mitsuru Hirota, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/761,251

(22) Filed: Jan. 22, 2004

(30) Foreign Application Priority Data
Mar. 25, 2003 (JP) 2003-083788

(51) Int. Cl. G06F 17/60

(52) U.S. Cl. 705/15

(57) ABSTRACT

A buyer proposes the order quantity of a commodity to a vendor through a computer network. The vendor terminal stores commodity ID, an acceptable increase value and an acceptable decrease value for each commodity into storage. The acceptable increase/decrease values indicate the values that can be increased/decreased from a proposal order quantity. The vendor terminal reads the acceptable increase/decrease values corresponding to the designated commodity ID from the storage when the commodity ID, the proposal order quantity for the commodity and buyer ID are input. The vendor terminal determines acceptable order range whose maximum value is the sum of the proposal order quantity and the acceptable increase value, and whose minimum value is found by subtracting the acceptable decrease value from the proposal order quantity. The vendor terminal transmits the proposal order quantity and the acceptable order range to the buyer terminal through the computer network.

### BACKGROUND OF THE INVENTION

1. Field of the invention

The present invention relates to an order proposal method for a commodity vendor to propose an order quantity of a commodity for a commodity buyer through a computer network, an order proposal program to make a computer, which can communicate with a buyer's computer, execute the above order proposal method, and a computer-readable recording medium storing such an order proposal program.

2. Prior art

In a conventional distribution process, a commodity buyer (referred to as a “buyer”, hereinafter) sends an order with specifying a desired commodity quantity and a delivery period to a commodity vendor (referred to as a “vendor”, hereinafter), and the vendor receives the order when the vendor will be able to deliver the commodities of the specified quantity until the specified delivery period, in general.

However, when the brand of a maker or a wholesaler as a vendor has goodwill, a vendor may assign the quantity of delivery of commodities to a retail shop as a buyer.

Further, if dealings with a specific buyer and a specific vendor become constant, a vendor secures stocking of commodities in expectation of a certain order quantity from the buyer and prepares the shipment of the commodities.

In such a case, a vendor may propose commodities to be ordered and the order quantities thereof to buyer in consideration of situations, such as the previous delivery result and fashion of the commodities before the buyer sends an order to the vendor. However, the order proposals may not agree with an original purchase plan of a buyer (when a buyer is a consumer) or an original sales plan of a buyer (when a buyer is a retailer). When the order quantity proposed by a vendor does not agree with the purchase quantity desired by a buyer, the final order quantity is decided through negotiation between the vendor and the buyer.

For example, Japanese unexamined patent publication 2000-3112630 discloses the network system that enables negotiation for deciding the final order quantity by communications through the computer network. According to the network system disclosed in the publication, a vendor and a buyer can determine the contents of an order through negotiation by communication through the computer network, and can conclude business negotiation.

However, since a vendor proposes the order quantity convenient for delivery of commodities to a buyer in a negotiation process, it may takes long time to conclude business negotiation even if such a network system is employed. Further, there may be case where a vendor must start the shipment preparation such as packing in anticipation of the order quantity of a buyer for timely delivery of the commodities. In such a case, if the proposal order quantity expected by the vendor would be greatly different from the actual order quantity, it may take a trouble with re-packing of unpacked luggage etc., or troubles may be caused in the delivery of commodities because of the shipment mistake based on data correction.

### SUMMARY OF THE INVENTION

An object of the present invention is to provide an improved order proposal method that is capable of avoiding troubles about order receiving when a vendor proposes commodities being targets of order and order quantities thereof to a buyer through a computer network.

Another object of the present invention is to provide an order proposal program to make a computer, which can communicate with a buyer's computer, execute the above order proposal method, and a computer-readable recording medium storing such an order proposal program.

An order proposal method of the present invention by which a vender proposes the order quantity of a commodity to a buyer through a computer network includes:

storing commodity ID, an acceptable increase value and an acceptable decrease value having correlation with each other for each commodity into storage of a computer connected to the computer network, the acceptable increase value indicating the value that can be increased from a proposal order quantity for a commodity and the acceptable decrease value indicating the value that can be decreased from the proposal order quantity;

reading the acceptable increase value and the acceptable decrease value corresponding to the designated commodity ID from the storage when the commodity ID, the proposal order quantity for the commodity and buyer ID are input to the computer;

determining acceptable order range whose maximum value is the sum of the proposal order quantity and the acceptable increase value, and whose minimum value is found by subtracting the acceptable decrease value from the proposal order quantity; and

transmitting the proposal order quantity and the acceptable order range to the buyer specified by the buyer ID through the computer network.

With this construction, when the vendor inputs the proposal order quantity and the ID information of the buyer to the computer, the acceptable order range of the commodity is automatically calculated based on the acceptable increase/decrease values stored in the storage. Then, the proposal order quantity and the acceptable order range are informed to the buyer. As a result, since the buyer can acknowledge the acceptable order range, within which the vendor assures certain purchase of the commodity, before the ordering, the buyer can select the order quantity of the commodity within the acceptable order range even if the proposal order quantity does not agree with the buyer's plan. Since the order quantity selected by the buyer falls within the range expected by the vendor, the vendor can adjust quickly and correctly the quantity of the commodity and can deliver it quickly even if the commodities were prepared for delivery before receiving the order.

Further, the storage may store the information about plural kinds of commodities.

Still further, the storage may store capacity of a container box for a commodity having correlation with the commodity ID. When the capacity of the container box is stored, the computer can correct the acceptable order range to be transmitted to the buyer. That is, the computer can calculate the ratio of reminder when the maximum value is divided by the capacity with respect to the capacity. If the ratio is smaller than a predetermined value, the computer can change the acceptable order range by subtracting the reminder from the maximum value. Such a change of the maximum value of the acceptable order range almost equally distributes the commodities to the container boxes even if the quantity of the commodity is not divided by the capacity. This increases efficiency of the delivery.

Moreover, the storage may store vendor's inventory quantity of a commodity having correlation with the commodity ID. When the vendor's inventory quantity of the commodity is stored, the computer can give a warning when the maximum value of the acceptable order range exceeds the vendor's inventory quantity. Therefore, the vendor can take measures in response to the warning, for example, the vendor may increase inventory quantity, or may change the maximum value of the acceptable order range.

The maximum and minimum values of the calculated acceptable order range or that after correction may be corrected. With this construction, if situation changes after various kinds of information is recorded, the vendor can take measures.

### DESCRIPTION OF THE ACCOMPANYING DRAWINGS

FIG. 1 is a block diagram showing the hardware composition of the computer network system on which the order proposal method of the present invention is executed;

FIG. 2 is a table showing the outline data structure of a commodity master;

FIG. 3 is a table showing the outline data structure of an inventory master;

FIG. 4 is a table showing the outline data structure of a retail information file;

FIG. 5 is a flow chart showing process contents of a commodity-master-maintenance program;

FIG. 6 is a flow chart showing process contents of an order proposal program;

FIG. 7 shows a proposal order quantity input screen;

FIG. 8 shows an acceptable-order-range displaying screen; and

FIG. 9 shows an ordering screen.

### DESCRIPTION OF THE PREFERRED EMBODIMENTS

Hereinafter, an embodiment of the present invention will be described with reference to drawings.

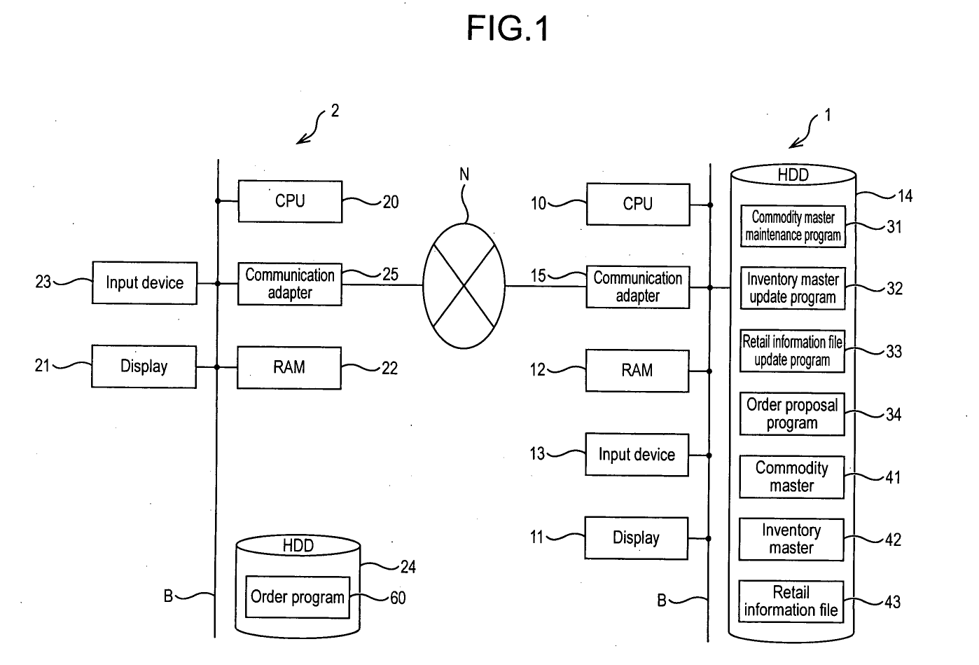

FIG. 1 is a block diagram showing the hardware composition of the computer network system on which the order proposal method of the present invention is executed. As shown in FIG. 1, the computer network system consists of a plurality of user terminals 1 and 2 that can communicate to each other through a computer network N. The vendor terminal 1 is managed and operated by a vendor who sells commodities. The buyer terminal 2 is managed and operated by a buyer who buys commodities at a middle point in the distribution process. Since the vendor terminal 1 and the buyer terminal 2 are general computers with communication function, they are similar to each other in hardware construction. On the other hand, they are different in software construction (programs and data) because of different functions required.

In a distribution process, one vendor sells commodities to a plurality of buyers and one buyer buys commodities from a plurality of vendors, in general. Accordingly, there are many vendor terminals 1 and many buyer terminals 2 in the computer network system. Further, at a middle point in the distribution process, a certain trader (for example, wholesaler) may become a buyer in a relation with an upstream trader (for example, manufacturer) and a vendor in a relation with a down-stream trader (for example, a retailer). Therefore, one computer can have the function as the buyer terminal 2 and the function as the vendor terminal 1. However, in the following description, for an easy understanding, each computer is treated as a single function terminal with focusing on a certain relationship between a buyer and a vendor, that is, the buyer terminal 2 has a function of the buyer terminal only and the vendor terminal 1 has a function of the vendor terminal only. FIG. 1 shows a pair of the buyer terminal 2 and the vendor terminal 1.

In FIG. 1, the computer network N is the Internet, a personal computer communication network, or the like. Peer-to-peer data exchange, E-mail and an information notice using the Web page etc., are available as a communication through the computer network N.

The vendor terminal 1 is an above-mentioned general computer that includes a CPU (Central Processing Unit) 10 for controlling the entire system of the vendor terminal 1, a display 11, a RAM (Random Access Memory) 12, an input device 13, a hard disk drive 14 and a communication adapter 15. These parts of the hardware are mutually connected by a bus B. The display 11 shows a screen data generated by the CPU 10. The input device 13 employs a keyboard and a mouse to input various commands and data to the CPU 10. The RAM 12 is a main memory on which a working area used by the CPU 10 is developed. The communication adapter 15 is an interface with the computer network N, such as a modem or a TA (Terminal Adapter).

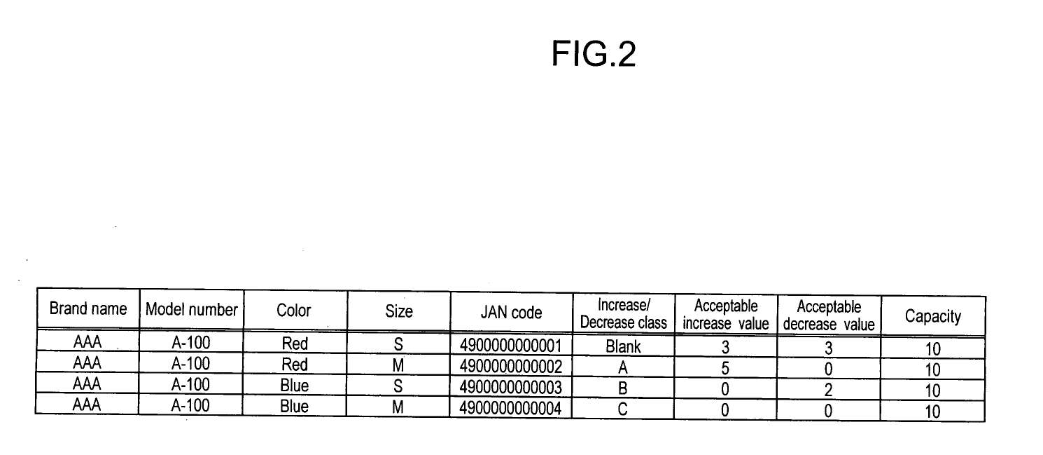

The hard disk drive 14 is storage for storing various programs and various data. The hard disk drive 14 stores a commodity master 41, an inventory master 42 and a retail information file 43. The commodity master 41 is a table for managing the order-received conditions (an acceptable order range of the order quantity proposed to the buyer, capacity of a container box for a commodity, etc.). FIG. 2 shows the outline data structure of the commodity master 41.

As shown in FIG. 2, the commodity master 41 contains a record for each commodity. And then, each record has fields of a brand name of a commodity (a manufacturer name, a house brand, a name of a commodity, etc.), a color (a color of a commodity), size (size of a commodity), a JAN code (ID number coded by bar code uniquely given to a commodity), increase/decrease class, an acceptable increase value, an acceptable decrease value, and capacity of a container box for a commodity.

Values “blank”, “A”, “B” and “C” can be set in the increase/decrease class field. The value “blank” means that the basic value of the proposal order quantity can be increased and decreased. The value “A” means that the basic value of the proposal order quantity can be increased but cannot be decreased. The value “B” means that the basic value of the proposal order quantity can be decreased but cannot be increased. The value “C” means that the basic value of the proposal order quantity cannot be changed. When the value of the increase/decrease class field is “blank” or “A”, quantity (value) that can be increased from the basic value of the proposal order quantity is set in the acceptable increase value field. Further, when the value of the increase/decrease class field is “blank” or “B”, quantity (value) that can be decreased from the basic value of the proposal order quantity is set in the acceptable decrease value field. Moreover, the quantity of the same commodity that can be contained in the container box is set to the capacity field.

Moreover, the inventory master 42 is a table for managing the vendor's inventory quantity for each commodity that is stoked in the vendor who manages the vendor terminal 1. FIG. 3 is the table showing the outline data structure of the inventory master 42. As shown in FIG. 3, the inventory master 42 contains a record for each commodity. A JAN code and an inventory quantity (it is the quantity of the commodity that can be delivered immediately to a buyer) of a commodity are recorded on each record.

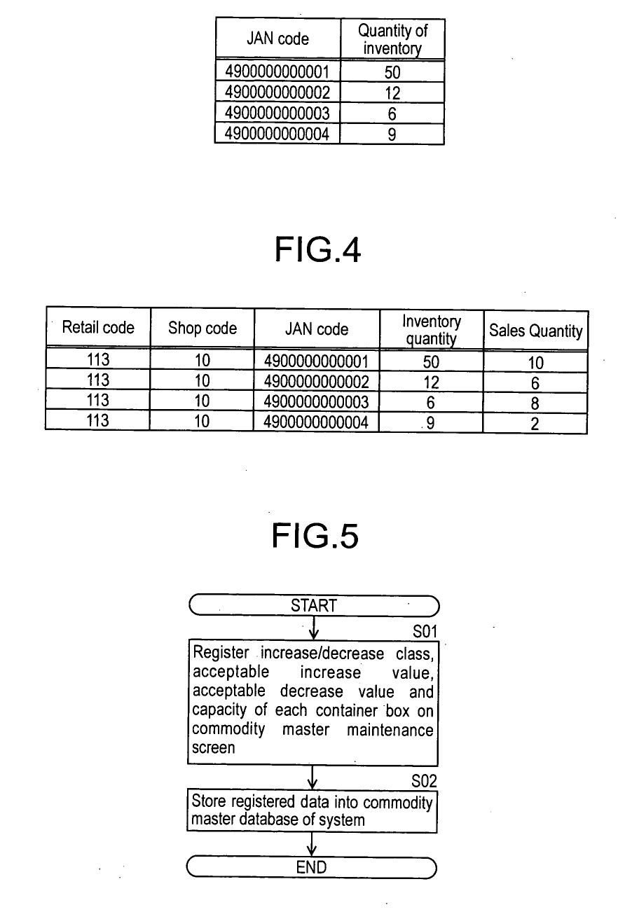

Still further, the retail information file 43 is a data file that is used to manage inventory quantity and sales quantity of each commodity for each shop of the buyer in the case where the buyer who does constantly business with the vendor managing the vendor terminal 1 is a retailer. FIG. 4 is a table showing the outline data structure of the retail information file 43. As shown in FIG. 4, the retail information file 43 contains a record for each commodity of each shop of each buyer. A retail code (a code for identifying a buyer), a shop code (a code for identifying a shop), a JAN code of the commodity, an inventory quantity of the commodity and a sales quantity of the commodity (a quantity sold after the previous delivery) are recorded on each record.

On the other hand, the hard disk drive 14 stores a commodity master maintenance program 31, an inventory master update program 32, a retail-information-file-update program 33 and an order proposal program 34 besides an OS (Operation System) as a basic program and various device drivers.

The commodity master maintenance program 31 is a program for updating (adding a new record, changing contents of the existing record or deleting the existing record) the commodity master 41. The commodity master maintenance program 31 is read by the CPU 10 onto the RAM 12 when an execution command that specifies the file name is input into the CPU 10 through the input device 13. Henceforth, the CPU 10 starts a process according to the commodity master maintenance program 31. FIG. 5 is a flow chart showing process contents of the commodity master maintenance program 31.

At the first step S01, the CPU 10 displays the commodity master maintenance screen (not shown) on the display 11. The commodity master maintenance screen includes a column for choosing an updating kind, a column for selecting a record when an existing record is to be changed or deleted, columns for inputting new contents for the respective items when a new record is added or an existing record is changed, and an updating button for reflecting the update contents input in the respective columns to the commodity master 41.

An operator of the vendor terminal 1 can set data in each input column by operating the input device 13. For example, when the operator selects addition of a new record as the updating kind, the operator registers necessary data in the columns of the brand name, the model number, the color, the size, and the JAN code. After that, the operator inputs one of “A”, “B” and “C” into the input column of the increase/decrease class or keeps it blank, and registers values defining the acceptable order range of the proposal order quantity that is acceptable to the vendor into the input columns of the acceptable increase value and the acceptable decrease value. Finally, the operator registers the capacity of the container box in the input column of the capacity. When the operator clicks the updating button after inputting the data in the respective column, the CPU 10 advances the process to S02.

At S02, the CPU 10 updates the commodity master 41 based on the data input in the respective input columns. For example, when addition of a new record is set as the updating kind, the CPU 10 additionally stores a new record containing the input data registered in the respective input column into the commodity master 41. Finishing S02, the CPU 10 completes the process of the commodity master maintenance program 31.

The inventory master update program 32 is a program for updating (adding a new record, changing contents of the existing record or deleting the existing record) the inventory master 42. The inventory master update program 32 is read by the CPU 10 onto the RAM 12 when an execution command that specifies the file name is input into the CPU 10 through the input device 13. Henceforth, the CPU 10 starts a process according to the inventory master update program 32. During the process, the CPU 10 updates the inventory master 42 based on inventory update transaction data that specifies the contents of updating of the inventory master 42. The inventory update transaction data is input by the input device 13 using an input screen displayed on the display 11 in the same manner as the commodity-master-maintenance screen displayed by the commodity-master-maintenance program 31. However, the transaction data may be input by another means.

The retail-information-file-update program 33 is a program for updating (adding a new record, changing contents of the existing record or deleting the existing record) the retail information file 43. The retail-information-file-update program 33 is read by the CPU 10 onto the RAM 12 when an execution command that specifies the file name is input into the CPU 10 through the input device 13. Henceforth, the CPU 10 starts a process according to the retail-information-file-update program 33. During the process, the CPU 10 updates the retail information file 43 based on retail information transaction data that specifies the contents of updating of the retail information file 43. The retail information transaction data is received from the respective buyer terminals 2 through the computer network N and the communication adapter 15. However, the transaction data may be input by another means.

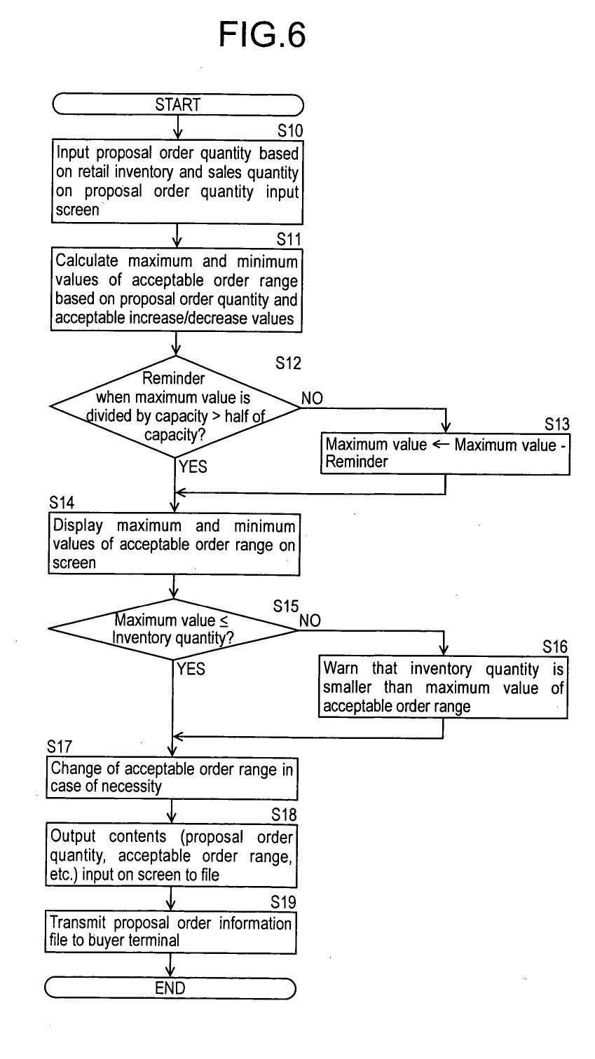

The order proposal program 34 is a program for determining the proposal order quantity and the acceptable order range for each commodity for each buyer based on the commodity master 41 and the inventory master 42, and for transmitting an order proposal information file containing the determined contents to the buyer terminal 2. The order proposal program 34 is read by the CPU 10 onto the RAM 12 when an execution command that specifies the file name is input into the CPU 10 through the input device 13. Henceforth, the CPU 10 starts a process according to the order proposal program 34. FIG. 6 is a flow chart showing process contents of the order proposal program 34.

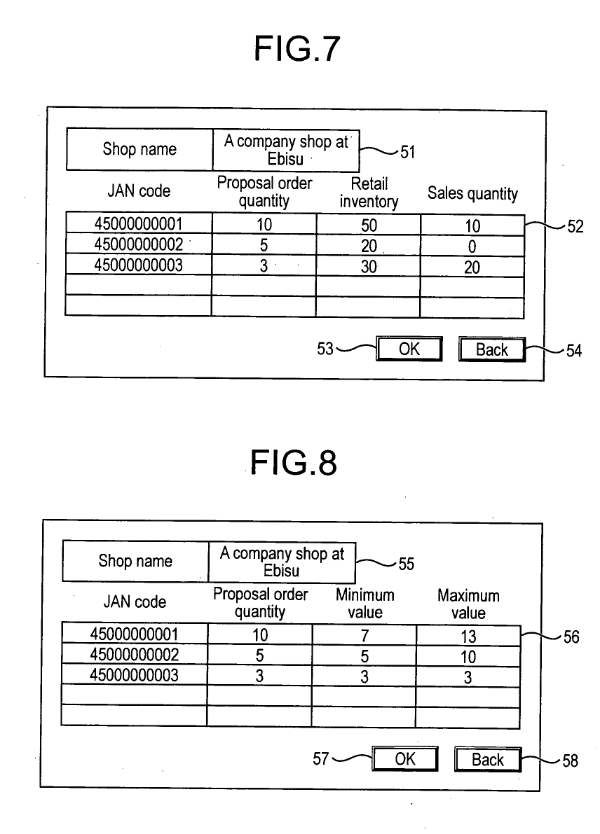

At the first step S10, the CPU 10 displays the proposal order quantity input screen on the display 11. As shown in FIG. 7, the proposal order quantity input screen includes a retail shop name column 51 to input a name of a shop of a buyer to be proposed, a proposal input table 52 for setting proposal order quantity for each commodity, an OK button 53 and a back button 54. Horizontal lines in the proposal input table 52 correspond to the commodities, respectively, and vertical columns correspond to JAN code of a commodity, a proposal order quantity, a retail inventory quantity, and a sales quantity, respectively.

In initial condition, all input boxes of the columns 51 and all cells of the table 52 in the order proposal quantity input screen are blank. When an operator inputs a shop name in the retail shop name column 51 by operating the input device 13 of the vendor terminal 1, the CPU 10 retrieves all of the hit records corresponding to the shop from the retail information file 43 and displays the JAN code, the inventory quantity and the sales quantity for each commodity in the respective cells of the proposal input table 52. The operator of the vendor terminal 1 determines the order proposal quantity for each commodity with reference to the information displayed in the proposal input table 52. When the operator clicks the OK button 53 after the operator has input determined proposal order quantities for the respective commodities in the cells of the proposal input table 52, the CPU 10 brings the process to S11.

At S11, the CPU 10 searches the commodity master 41 based on the JAN code of each commodity for the records whose proposal order quantity input in the proposal input table 52 is equal to or larger than 1. And the CPU 10 reads the increase/decrease class, the acceptable increase value and the acceptable decrease value from each of the hit record.

Then the CPU 10 calculates the minimum and maximum values of the acceptable order range for each commodity based on the proposal order quantity input in the proposal input table 52 and the data retrieved from the commodity master 41. The maximum value is equal to the sum of the proposal order quantity and the acceptable increase value when the increase/decrease class is blank or “A”, or is equal to the proposal order quantity itself when the increase/decrease class is “B” or “C”. The minimum value is equal to the difference subtracting the acceptable decrease value from the proposal order quantity when the increase/decrease class is blank or “B”, or is equal to the proposal order quantity itself when the increase/decrease class is “A” or “C”. For example, assuming that the proposal order quantity is equal to “5” for the commodity shown in FIG. 2 whose JAN code is “4900000000001”, the minimum value is equal to “2” and the maximum value is equal to “8”. Further, when the proposal order quantity is equal to “4” for the commodity shown in FIG. 2 whose JAN code is “4900000000002”, the minimum value is equal to “4” and the maximum value is equal to “9”. When the proposal order quantity is equal to “5” for the commodity shown in FIG. 2 whose JAN code is “4900000000003”, the minimum value is equal to “3” and the maximum value is equal to “5”. Still further, when the proposal order quantity is equal to “7” for the commodity shown in FIG. 2 whose JAN code is “4900000000004”, the minimum value is equal to “7” and the maximum value is equal to “7”.

At the next step S12, the CPU 10 reads the capacity for each of the target commodities whose maximum and minimum values are calculate at S10 from the commodity master 41. Then, the CPU 10 checks whether the reminder when the maximum value is divided by the capacity is larger than half of the capacity or not for each target commodity. The reminder means the fraction when the commodities of the maximum value are packed in the container boxes. When the reminder is equal to or smaller than the half capacity, the CPU 10 judges that the fraction becomes too small to keep the efficiency of delivery, the CPU 10 sets a new maximum value that is calculated by subtracting the reminder from the previous maximum value calculated at S11. For example, assuming that the proposal order quantity is equal to “10” for the commodity shown in FIG. 2 whose JAN code is “4900000000001”, the CPU 10 calculates that the maximum value is equal to “13” at S11. When the maximum value “13 ” is divided by the capacity “10”, the quotient is “1” and the reminder is “3”. Since the reminder “3” is smaller than the half capacity “5”, the CPU 10 sets a new maximum value “10” that is calculated by subtracting the reminder “3” from the previous maximum value “13” calculated at S11. Therefore, the acceptable order range becomes from “7” to “10”. If the new maximum value will become smaller than the minimum value, the CPU 10 does not change the maximum value calculate at S10 to avoid contradiction in the acceptable order range. Finishing S13, the CPU 10 brings the process to S14.

On the other hand, if it is determined that the reminder is larger than the half capacity at S12, the CPU 10 judges that the fraction does not decrease the efficiency of delivery, bringing the process to S14.

At S14, the CPU 10 displays an acceptable-order-range displaying screen on the display 11 based on the minimum value calculated at S11 and the maximum value calculated at S11 or changed at S14 for each commodity. As shown in FIG. 8, the acceptable-order-range displaying screen includes a shop name column 55 to indicate the shop of the buyer to be proposed, a proposal list table 56 for displaying the proposal order quantity and the acceptable order range (the minimum and maximum values) for each commodity, an OK button 57 and a back button 58. Horizontal lines in the proposal list table 56 correspond to the commodities, respectively, and vertical columns correspond to JAN code of the commodity, the proposal order quantity input at S10, the minimum value and the maximum value, respectively. In initial condition, the proposal list table 56 shows the JAN code, the proposal order quantity input at S10, the minimum value calculated at S11 and the maximum value calculated at S11 or changed at S13 for each commodity.

At the next step S15, the CPU 10 searches the inventory master 42 based on the JAN code of each of the commodities displayed on the acceptable-order-range displaying screen at S14 to read the vendor's inventory quantity for each commodity. Then the CPU 10 checks whether the maximum value displayed on the acceptable-order-range displaying screen at S14 exceeds the vendor's inventory quantity or not for each commodity. If

At the next step S15, the CPU 10 searches the inventory master 42 based on the JAN code of each of the commodities displayed on the acceptable-order-range displaying screen at S14 to read the vendor's inventory quantity for each commodity. Then the CPU 10 checks whether the maximum value displayed on the acceptable-order-range displaying screen at S14 exceeds the vendor's inventory quantity or not for each commodity. If the maximum value exceeds the corresponding inventory quantity, the CPU 10 shows the warning to warn that the inventory quantity is smaller than the maximum value of the acceptable order range on the display 11 at S16. For example, assuming that the proposal order quantity is equal to “10” for the commodity shown in FIG. 2 whose JAN code is “4900000000002”, the minimum value is equal to “10 ” and the maximum value is equal to “15”. However, since the maximum value “15” exceeds the inventory quantity “12” shown in FIG. 3, the CPU 10 shows the message “Warning! Exceed inventory quantity”, for example. Finishing S16, the CPU 10 brings the process to S17.

On the other hand, if the CPU 10 judges that the maximum value is equal to or smaller than the corresponding inventory quantity, the CPU 10 directly brings the process to S17.

At S17, the CPU 10 accepts the final correction input for the maximum and minimum values for each commodity in the proposal list table 56. During the correction input, an operator can overwrite each value displayed in the proposal displaying screen at the time into the file (the order proposal information file).

At the next step S19, the CPU 10 transmits the order proposal information file output at S18 to the buyer terminals 2 that are managed by the buyers shown by the shop names included in the file. Finishing S19, the CPU 10 completes the process of the order proposal program 34.

The description goes back to FIG. 1. Since the buyer terminal 2 is an above-mentioned general computer, it consists of a CPU (Central Processing Unit) 20, a display 21, a RAM (Random Access Memory) 22, an input device 23, a hard disk drive 24 and a communication adapter 25 in the same manner as the vendor terminal 1. However, the hard disk drive 24 of the buyer terminal 2 stores an ordering program 60 to execute an ordering process based on the order proposal information file received from the vendor terminal 1.

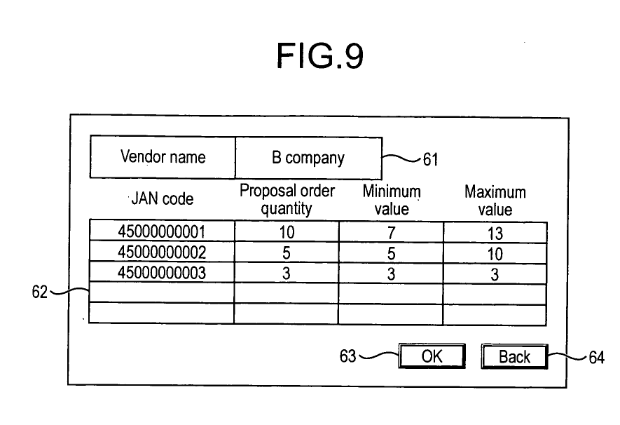

When a predetermined command is input from the input device 23 after the order proposal information file from the vendor terminal 1 is received, the CPU 20 reads the ordering program 60 onto the RAM 22 and executes the process according to the ordering program 60. That is, the CPU 20 reads the received order proposal information file, and displays an ordering screen based on the contents (the JAN code, the proposal order quantity and the acceptable order range for each commodity) of the file. As shown in FIG. 9, the ordering screen includes a vendor name column 61 to indicate the name of the vendor who transmits the order proposal information file, an ordering list table 62 for displaying the proposal order quantity and the acceptable order range(the minimum and maximum values) for each commodity and for inputting the settled order quantity, an OK button 63 and a back button 64. Horizontal lines in the ordering list table 62 correspond to the commodities, respectively, and vertical columns correspond to JAN code of the commodity, the proposal order quantity, the minimum value and the maximum value, respectively. In initial condition, the ordering list table 62 shows the JAN code, the proposal order quantity, the minimum value and the maximum value, which are stored in the order proposal information file, for each commodity.

If the operator of the buyer terminal 2 can accept the proposal order quantities for the listed commodities, the operator may clicks the OK button 63. This fixes the order as-is.

On the contrary, if the operator cannot accept the proposal order quantity for any commodity, the operator may overwrite the proposal order quantity of the commodity displayed in the ordering list table 62 with desired quantity within the acceptable order range(from the minimum value to the maximum value). Then the operator clicks the OK button 63.

The CPU 20 confirms the quantities for the respective commodities displayed in the column of the proposal order quantities in the ordering list table 62 at the time when the OK button 63 is clickd. Then the CPU creates an ordering message that includes the confirmed order quantities with the corresponding JAN codes in an EDI (Electric Data Interchange) format and transmits the message to the vendor terminal 1 that has transmitted the order proposal information file.

If the operator of the buyer terminal 2 cannot accept the acceptable order range for any commodity (including the case where the buyer would not like to order the commodity), the operator must clear the proposal order quantity for the commodity in the ordering list table 62 before the operator clicks the OK button 63. Then, the order of this commodity will not be included in the ordering message.

As described above, according to the order proposal method of the embodiment built on the computer network, a vendor can determine the proposal order quantities for the respective commodities that are sold by the vendor in consideration of the vendor's inventory, distribution ratios for the respective buyers, the inventories and sales quantities of the respective buyers. The vendor can inform the proposal order quantity for the buyer terminal 2 of each buyer through the computer network N.

Further, the vendor can set the increase/decrease class, the acceptable increase value and the acceptable decrease value in the commodity master 41 in order to have some flexibility about the proposal order quantity for each commodity. Therefore, the acceptable order range is automatically calculated based on the settings in the commodity master 41, it is informed to the buyer terminal 2.

If the operator of the buyer terminal 2 accepts the proposal order quantities for the respective commodities informed through the computer network N, the operator returns the ordering message to the vendor terminal 1 without changing the proposal order quantities. Even if the operator of the vendor cannot accept the proposal order quantity for any commodity due to its sales strategy, since the buyer can acknowledge the acceptable order range, within which the vendor assures certain purchase of the commodity, the buyer can change the order quantity within the acceptable order range and can transmit the ordering message including the changed order quantity to the vendor terminal 1.

Further, since the order quantity for each commodity in the ordering message from the buyer is restricted within the acceptable order range, the vendor is able to prepare the shipment by packing the commodities into the container boxes before the vendor actually receives the ordering massage. This avoids the complicatedness of the correspondence accompanying change of the contents of the order, and prevents delay of the shipment and the mistake due to data correction.

In addition, if the vendor accommodates the comparison result between the proposal order quantity in the transmitted order proposal information file and the actual order quantity in the received ordering message for each commodity for each buyer, the vendor can utilize the accommodation as reference information for determining the proposal order quantity for each commodity at the next time or can utilize for negotiation with the buyer.

According to the present invention described above, since a vendor can inform the acceptable order range within which a buyer can change the order quantity to a buyer when the vendor proposes the order quantity for each commodity to the buyer through a computer network, troubles about order receiving can be reduced.

What is claimed is:

1. An order proposal method by which a vendor proposes the order quantity of a commodity to a buyer through a computer network, said method comprising:
storing commodity ID, an acceptable increase value and an acceptable decrease value having correlation with each other for each commodity into storage of a computer connected to said computer network, said acceptable increase value indicating the value that can be increased from a proposal order quantity for a commodity and said acceptable decrease value indicating the value that can be decreased from said proposal order quantity;
reading the acceptable increase value and the acceptable decrease value corresponding to the designated commodity ID from said storage when the commodity ID, the proposal order quantity for the commodity and buyer ID are input to said computer;
determining acceptable order range whose maximum value is the sum of said proposal order quantity and said acceptable increase value, and whose minimum value is found by subtracting said acceptable decrease value from said proposal order quantity; and
transmitting said proposal order quantity and said acceptable order range to the buyer specified by said buyer ID through said computer network.

2. An order proposal program used in a terminal computer that can communicate with another computer through a computer network and has storage storing commodity ID, an acceptable increase value and an acceptable decrease value having correlation with each other for each commodity, said acceptable increase value indicating the value that can be increased from a proposal order quantity for a commodity and said acceptable decrease value indicating the value that can be decreased from said proposal order quantity, said program causing said terminal computer to execute the procedures of:
reading the acceptable increase value and the acceptable decrease value corresponding to the designated commodity ID from said storage when the commodity ID, the proposal order quantity for the commodity and buyer ID are input to said computer;
determining acceptable order range whose maximum value is the sum of said proposal order quantity and said acceptable increase value, and whose minimum value is found by subtracting said acceptable decrease value from said proposal order quantity; and
transmitting said proposal order quantity and said acceptable order range to the buyer specified by said buyer ID through said computer network.

3. A computer-readable recording medium storing an order proposal program used in a terminal computer that can communicate with another computer through a computer network and has storage storing commodity ID, an acceptable increase value and an acceptable decrease value having correlation with each other for each commodity, said acceptable increase value indicating the value that can be increased from a proposal order quantity for a commodity and said acceptable decrease value indicating the value that can be decreased from said proposal order quantity, said program causing said terminal computer to execute the procedures of:
reading the acceptable increase value and the acceptable decrease value corresponding to the designated commodity ID from said storage when the commodity ID, the proposal order quantity for the commodity and buyer ID are input to said computer;
determining acceptable order range whose minimum value is the sum of said proposal order quantity and said acceptable increase value, and whose minimum value is found by subtracting said acceptable decrease value from said proposal order quantity; and
transmitting said proposal order quantity and said acceptable order range to the buyer specified by said buyer ID through said computer network.

4. The order proposal program according to claim 2, wherein said storage further stores capacity of a container box for a commodity having correlation with said commodity ID, said program further causing said terminal computer to execute the procedures of:
reading the capacity corresponding to the input commodity ID from said storage;
calculating the ratio of reminder when said maximum value is divided by said capacity with respect to said capacity; and
changing said acceptable order range to be transmitted to said buyer by subtracting said reminder from said maximum value when said ratio is smaller than a predetermined value.

5. The order proposal program according to claim 2 or 4, wherein said storage further stores vendor's inventory quantity of a commodity having correlation with the commodity ID, said program further causing said terminal computer to execute the procedures of:
reading the vendor's inventory quantity of the commodity corresponding to the input commodity ID from said storage; and
giving a warning when said maximum value of said acceptable order range exceeds said vendor's inventory quantity.

6. The order proposal program according to claim 2 or 4, further causing said terminal computer to execute the procedures of:
correcting said maximum and minimum values of said acceptable order range when a correction value for said maximum or minimum value is input.
